(19) United States
(12) Patent Application Publication
(10) Pub. No.: US 2022/0030128 A1
(43) Pub. Date: Jan. 27, 2022

(54) OFFICE MACHINE WITH INTELLIGENT SLEEP AND WAKE FUNCTION AND CONTROL METHOD THEREOF

(71) Applicant: AVISION INC., Hsinchu (TW)

(72) Inventor: CHUN-CHIEH LIAO, Hsinchu (TW)

(21) Appl. No.: 17/355,199

(22) Filed: Jun. 23, 2021

(30) Foreign Application Priority Data
Jul. 27, 2020 (TW) 109125268

(51) Int. Cl. H04N 1/00; G06K 9/00

(52) U.S. Cl. CPC H04N 1/00896; G06K 9/00255; H04N 1/00904; H04N 1/00381

(57) ABSTRACT

An office machine with intelligent sleep and wake function and a control method thereof are introduced. The office machine comprises a storage module, image module, processing module, and power supply module. The processing module is connected to the storage module, image module, and power supply module. The storage module stores user data and first feature data. The processing module obtains a user image from the image module to generate second feature data and then process the first and second feature data to generate comparison result information. After determining user confirmation information according to the comparison result information, the processing module sends a first control signal to the power module, such that the office machine wakes up automatically from sleep. The office machine wakes up automatically when a user approaches the office machine, so as to save time and improve work efficiency and ease of use.

### CROSS-REFERENCE TO RELATED APPLICATION

This non-provisional application claims priority under 35 U.S.C. § 119(a) on Patent Application No. 109125268 filed in Taiwan, R.O.C. on Jul. 27, 2020, the entire contents of which are hereby incorporated by reference.

### BACKGROUND OF THE INVENTION

### 1. Field of the Invention

The present disclosure relates to office machines and control methods thereof, and in particular to an office machine with intelligent sleep and wake function and a control method thereof.

### 2. Description of the Related Art

Owing to advancement of computer technology, various electronic devices for use in word processing are becoming more popular. The word processing-oriented electronic devices include printers, scanners, and office machines. The electronic devices are usually found in schools, offices, convenience stores, etc. Users scan paper-based documents with the electronic devices to output file data in electronic format or print out file data in electronic format to output paper-based documents. The electronic devices enable users to process related documents convenient and quickly.

With power being continuously supplied to related components of a conventional office machine, the office machine is ready to print. For instance, the office machine includes a fuser and components related thereto. The fuser is heated up; thus, carbon powder is heated up and fixedly compressed onto a sheet of paper to form an image, thereby printing out the sheet of paper carrying electronic file data. The fuser has to be heated up continuously in order to function well. To keep the office machine ready to print, it is necessary to supply power continuously to the fuser and components related thereto; as a result, the office machine consumes much power and causes excessive carbon emission. Furthermore, the office machine comes with a control panel illuminated all the time in order to be ready for use by users, thereby contributing to power consumption and carbon emission.

To save energy and reduce carbon emission, the office machine can operate in sleep mode (also known as power saving mode). After the office machine has been idle for a specific time period, related components of the office machine stop receiving power, and the office machine enters into sleep mode. To access the office machine again, users have to stand in front of the office machine and press the power button of the office machine in order to wake up the office machine from sleep mode. However, the woken office machine takes time supplying power to the related components again in order to restore their operable status and enable the office machine to function again.

Although the office machine with sleep function is effective in saving energy and reducing carbon emission, the office machine works slowly and inefficiently. It is because the office machine requires users to press its power button and then wait for the office machine to function again.

### BRIEF SUMMARY OF THE INVENTION

Considering that conventional office machines work slowly and inefficiently, it is an objective of the present disclosure to provide an office machine with intelligent sleep and wake function and a control method thereof to capture a user's images and process the images as soon as the user approaches the office machine. Upon confirmation that the user can access the office machine, the office machine wakes up automatically. Therefore, the present disclosure saves time, improves work efficiency and enhances ease of use.

To achieve at least the above objective, the present disclosure provides a control method of the office machine with intelligent sleep and wake function, causing the office machine to at least perform the steps of:

capturing a first user image;

comparing a plurality of user data and first feature data related thereto with second feature data generated from the first user image to generate comparison result information; and

waking up the office machine automatically from sleep mode upon determination of user confirmation information according to the comparison result information.

The image module captures a first user image of a user approaching the office machine. Then, the processing module compares second feature data generated according to the first user image and first feature data of the user. Upon confirmation that the comparison result indicates the user has authority to access the office machine, the processing module drives the power supply module to supply power, enabling the office machine to wake up automatically from sleep. Therefore, the office machine wakes up from sleep mode in response to an approaching user and thus spares the user the need to stand in front of the office machine to wait for its return to an operating state from sleep mode, thereby saving time, improving work efficiency and enhancing ease of use.

To achieve at least the above objective, the present disclosure provides an office machine with intelligent sleep and wake function, comprising:

a power supply module for supplying power to the office machine;

a storage module for storing a plurality of user data and first feature data related thereto;

an image module for capturing at least one first user image; and

a processing module connected to the power supply module, the storage module and the image module,

wherein the processing module generates second feature data according to the first user image, compares the second feature data with the first feature data related to the user data to generate comparison result information, and sends, upon determination of user confirmation information according to the comparison result information, a first control signal for driving the power supply module to enable the office machine to wake up automatically from sleep mode.

The image module captures a first user image of a user approaching the office machine. Then, the processing module compares second feature data generated according to the first user image and first feature data of the user. Upon confirmation that the comparison result indicates the user has authority to access the office machine, the processing module drives the power supply module to supply power, enabling the office machine to wake up automatically from sleep. Therefore, the office machine wakes up from sleep mode in response to an approaching user and thus spares the user the need to stand in front of the office machine to wait for its return to an operating state from sleep mode, thereby saving time, improving work efficiency and enhancing ease of use.

To achieve at least the above objective, the present disclosure provides an office machine with intelligent sleep and wake function, the office machine connecting to a cloud server via a network, the cloud server storing a plurality of user data and first feature data related thereto, the office machine comprising:

a power supply module for supplying power to the office machine;

a connection module connected to the cloud server via the network and adapted to effect data exchange;

an image module for capturing at least one first user image; and

a processing module connected to the power supply module, the storage module and the image module,

wherein the processing module generates second feature data according to the first user image, sends the second feature data to the cloud server via the connection module so as for the second feature data to be processed at the cloud server, obtains comparison result information by exchange, and sends, upon determination of user confirmation information according to the comparison result information, a first control signal for driving the power supply module to enable the office machine to wake up automatically from sleep mode.

The image module captures a first user image of a user approaching the office machine. Then, the processing module compares second feature data generated according to the first user image and first feature data of the user. Upon confirmation that the comparison result indicates the user has authority to access the office machine, the processing module drives the power supply module to supply power, enabling the office machine to wake up automatically from sleep. Therefore, the office machine wakes up from sleep mode in response to an approaching user and thus spares the user the need to stand in front of the office machine to wait for its return to an operating state from sleep mode, thereby saving time, improving work efficiency and enhancing ease of use.

### BRIEF DESCRIPTION OF THE DRAWINGS

FIG. 1 is a block diagram of an office machine with intelligent sleep and wake function according to the first preferred embodiment of the present disclosure.

FIG. 2 is another block diagram of the office machine with intelligent sleep and wake function according to the first preferred embodiment of the present disclosure.

FIG. 3 is a block diagram of the office machine with intelligent sleep and wake function according to the second preferred embodiment of the present disclosure.

FIG. 4 is a schematic view of the process flow of a control method of the office machine of the first preferred embodiment or the office machine of the second preferred embodiment according to the present disclosure.

### DETAILED DESCRIPTION OF THE INVENTION

To facilitate understanding of the object, characteristics and effects of this present disclosure, embodiments together with the attached drawings for the detailed description of the present disclosure are provided.

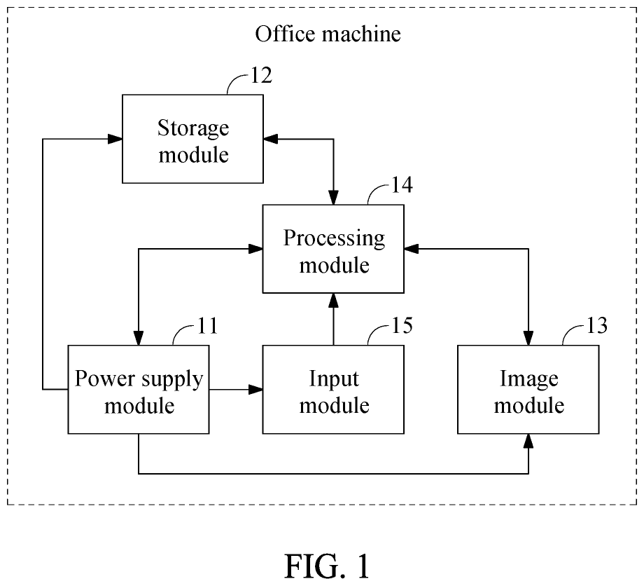

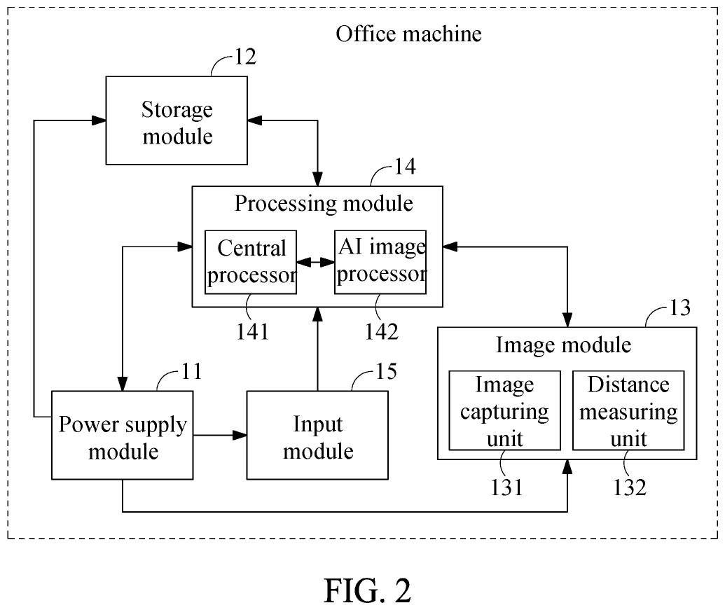

An office machine with intelligent sleep and wake function is provided according to the first preferred embodiment of the present disclosure. Referring to FIGS. 1, 2, the office machine comprises a power supply module 11, a storage module 12, an image module 13 and a processing module 14. The processing module 14 is electrically connected to the power supply module 11, the storage module 12 and the image module 13. The power supply module 11 is electrically connected to the storage module 12, the image module 13 and the other components (not shown) of the office machine of the present disclosure. The power supply module 11 supplies power to the office machine of the present disclosure. The storage module 12 stores a plurality of user data, first feature data related thereto, data to be processed by the processing module 14, or the other data. The image module 13 captures a first user image of a user and sends the first user image to the processing module 14 for processing. The processing module 14 processes data. In this embodiment, the office machine further comprises an input module 15 electrically connected to the power supply module 11 and the processing module 14 and adapted to be configured by users. The input module 15 is a touchscreen module, a key module or a combination thereof.

In this embodiment, the power supply module 11 is a power converter and has a power line. The power supply module 11 is connected between an electrical outlet and related components of the office machine to supply power to the related components of the office machine. The power supply module 11 may also be a rechargeable battery module. In this embodiment, the storage module 12 is a memory, including but not limited to a nonvolatile memory (dynamic random access memory, DRAM), a high disk drive (HDD), a flash memory, or a solid-state drive (also known as solid-state disk, SSD).

In this embodiment, the image module 13 comprises an image capturing unit 131 and a distance measuring unit 132. The image capturing unit 131 captures a first user image of a user. The distance measuring unit 132 measures a distance between a user and the office machine of the present disclosure. Further details of the image module 13 are described later. In this embodiment, the image capturing unit 131 is a camera or a camcorder, whereas the distance measuring unit 132 is an infrared distance meter or a time of flight (ToF) unit.

In this embodiment, the processing module 14 processes related data and the first user image captured by the image module 13. The processing module 14 comprises a central processor 141 and an AI image processor 142. The central processor 141 is electrically connected to the AI image processor 142. The central processor 141 processes related data. The AI image processor 142 has therein at least one image processing algorithm for processing images, so as to generate data which results from the processing of related images.

In the first preferred embodiment, if no users access the office machine of the present disclosure within a specific time period, the power supply module 11 stops supplying power to related components of the office machine temporarily under the control of the processing module 14, thereby enabling the office machine to enter into sleep mode (also known as power saving mode). Thus, in response to a user approaching the office machine, the image capturing unit 131 of the image module 13 captures a first user image of the user and sends the first user image to the processing module 14. After that, the AI image processor 142 of the processing module 14 processes the first user image with the image processing algorithm to generate and send second feature data to the central processor 141. Then, the central processor 141 compares the second feature data with the user data and first feature data which are stored in the storage module 12 to generate comparison result information. If the central processor 141 of the storage module 12 determines that the comparison result information is user confirmation information, the central processor 141 of the processing module 14 will send a first control signal to the power supply module 11 to drive the power supply module 11 to supply power to the related components of the office machine, such that the office machines wakes up automatically from sleep mode, so as to save time, improve work efficiency and enhance ease of use.

In this embodiment, the user data each comprises a user account password data, a user ID data and first feature data related thereto. The first feature data each comprises first face feature data. The first face feature data includes but is not limited to a lip-shaped outline, an eye-shaped outline, a skin color feature, an eyebrow-shaped outline, and a face outline. The second feature data comprises a second user face feature and face data. For example, the face data is face turning angle data.

In addition to determining that the comparison result information is the user confirmation information, the central processor 141 of the processing module 14 determines whether the face turning angle data of the second feature data satisfies an angle data. In an embodiment, the angle data is a turning angle range data to provide a dual determination mechanism described below. First, when the central processor 141 determines that the face turning angle data of the second feature data satisfies the turning angle range data, the central processor 141 determines that the comparison result information is the user confirmation information. Second, when the face turning angle data of the second feature data satisfies the turning angle range data, the processing module 14 drives the power supply module 11 to supply power, thereby enabling the office machine to wake up automatically from sleep mode. The dual determination mechanism is effective not only in confirming whether a user has authority to access the office machine but also in confirming whether the user intends to access the office machine, so as to avoid wrong judgement but ensure usage security. In an embodiment, the turning angle range data ranges from 0 degree to 15 degrees, i.e., turning the face by 0 degree to 15 degrees.

The central processor 141 of the processing module 14 compares the second feature data with the first feature data related to the user data to generate the comparison result information. When the central processor 141 of the processing module 14 finds the first feature data matching the second feature data, the central processor 141 of the processing module 14 confirms a corresponding user data according to the first feature data and thereby confirms that the user is the right person and has authority to access the office machine; thus, the comparison result information is the user confirmation data, and the central processor 141 of the processing module 14 determines whether the user has authority to access the office machine according to the user account password data and user ID data. Conversely, when the central processor 141 of the processing module 14 does not find the first feature data matching the second feature data, the central processor 141 of the processing module 14 confirms that the user is a wrong person and lacks authority to access the office machine; hence, the comparison result information is a user mistake data, and thus the central processor 141 of the processing module 14 refrains from taking any action.

In addition to determining whether a user intends to access the office machine according to the aforesaid face turning angle, a more effective, accurate way of determining whether a user intends to access the office machine is to use the distance measuring unit 132 of the image module 13 in measuring and capturing a plurality of distance data from the surroundings and then sending all the captured distance data to the central processor 141 of the processing module 14. After determining that one of the distance data reaches a distance threshold (including but not limited to a distance of five meters or less between the office machine and the user), the central processor 141 of the processing module 14 sends a driving signal to the image capturing unit 131 of the image module 13 to capture, process and judge the corresponding first user image in order to confirm whether the user is the right person and has authority to access the office machine. When the AI image processor 142 of the processing module 14 processes the first user image but does not generate the second feature data, the AI image processor 142 of the processing module 14 sends a no feature data generation notice data to the central processor 141 of the processing module 14 to instruct it to stop comparing the feature data. In other words, the first user image captured by the image capturing unit 131 of the image module 13 belongs to an object more closer to the office machine. Furthermore, although the distance measuring unit 132 keeps monitoring the surroundings to capture related distance data and thus keeps consuming power, the power consumed by the distance measuring unit 132 is insignificant and thus negligible.

The present disclosure provides three ways to prevent the office machine from being tampered with after use. First, the user sets the office machine to sleep mode with the input module 15. After receiving a sleep command data from the input module 15, the central processor 141 of the processing module 14 sends the power supply module 11 a second control signal whereby the power supply module 11 stops supplying power to the related components of the office machine temporarily, thereby causing the office machine to enter into sleep mode. Second, after the office machine has woken up automatically from sleep mode and finished an office task, such as printing, scanning, and sending/receiving fax, the central processor 141 of the processing module 14 sends the second control signal to the power supply module 11 (to cause the power supply module 11 to stop supplying power to the related components of the office machine temporarily and thus cause the office machine to enter into sleep mode) in response to receipt of third feature data generated by the AI image processor 142 in accordance with a second user image captured by the image capturing unit 131 of the image module 13. Third, after the office machine has woken up automatically from sleep mode and finished an office task, such as printing, scanning, and sending/receiving fax, the central processor 141 of the processing module 14 sends the power supply module 11 the second control signal whereby the power supply module 11 stops supplying power to the related components of the office machine temporarily, thereby causing the office machine to enter into sleep mode. Therefore, the present disclosure enables the office machine to enter into sleep mode, whether manually or automatically, to provide various protective mechanisms and promote usage security.

According to the present disclosure, the office machine wakes up from sleep mode in response to an approaching user and thus spares the user the need to stand in front of the office machine to wait for its return to an operating state from sleep mode, thereby saving time, improving work efficiency and enhancing ease of use.

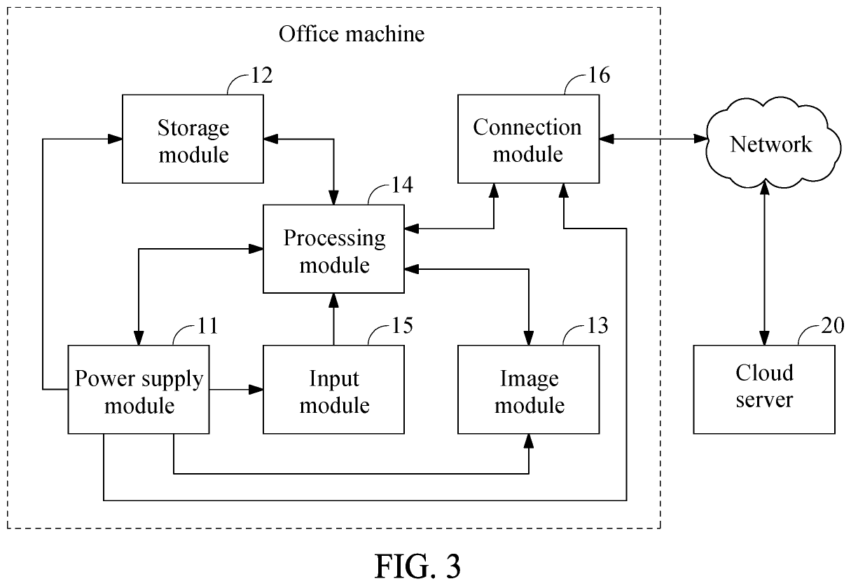

Regarding the office machine of the present disclosure, the second preferred embodiment illustrated by FIG. 3 is distinguished from the first preferred embodiment illustrated by FIG. 1 by technical features as follows: in the second preferred embodiment, a plurality of user data and first feature data related thereto are stored in a cloud server 20; a connection module 16 is connected to the power supply module 11 and the processing module 14; the second feature data is sent, via the connection module 16, to the cloud server 20 so as to be compared with the user data and first feature data related thereto, such that the comparison result information is obtained by exchange; the central processor 141 of the processing module 14 sends a data download request to the cloud server 20 via the connection module 16, such that the user data and first feature data related thereto are downloaded and stored in the storage module 12 in order to be compared in the office machine; and, in case of a negative comparison result, the second feature data will be sent from the processing module 14 to the cloud server 20 via the connection module 16 for comparison or be downloaded from the cloud server 20 to the office machine for storage.

In this embodiment, the connection module 16 is a wireless network module, including but not limited to a Wi-Fi module or a communication module, such as 2G, 3G, 4G, 5G or any communication module of a higher standard, whereas the connection module 16 is a cable network module, including but not limited to a network card.

In the first preferred embodiment of the present disclosure, a plurality of user data and first feature data related thereto are directly stored in the storage module 12 and thus can be compared conveniently and quickly. In the second preferred embodiment of the present disclosure, a plurality of user data and first feature data related thereto are stored in the cloud server 20 and subjected to integrated, convenient control, though they must be downloaded and updated prior to each instance of usage.

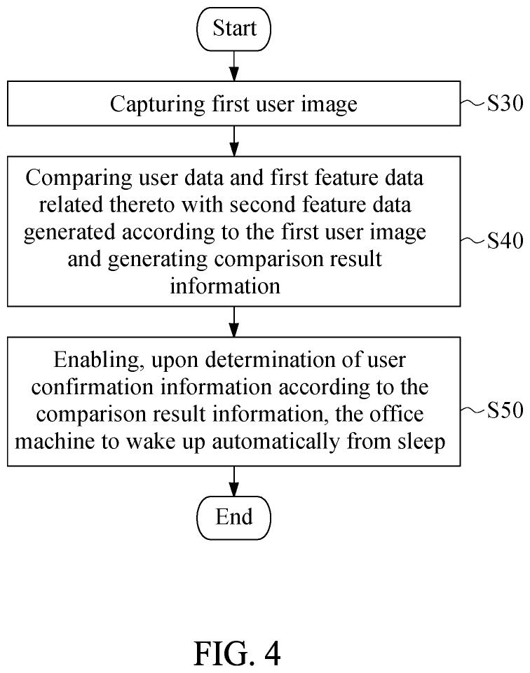

Referring to FIG. 4, a control method of an office machine with intelligent sleep and wake function is provided according to the present disclosure and comprises the steps of:

capturing the first user image (S30);

comparing a plurality of user data and first feature data related thereto with second feature data generated according to the first user image and generating the comparison result information (S40), wherein the user data each comprises the user account password data, the user ID data and first feature data related thereto, and the first feature data each comprises the first face feature data, wherein the second feature data comprises the second user face feature and the face turning angle data; and

enabling, upon determination of user confirmation information according to the comparison result information, the office machine to wake up automatically from sleep mode (S50).

Before capturing the first user image, the office machine captures a plurality of distance data. After determining that one of the captured distance data reaches a distance threshold, the office machine captures the first user image.

Upon determination of the user confirmation information according to the comparison result information, the office machine determines that face data of the second feature data satisfies the angle data and thereby wakes up automatically from sleep mode.

After waking up automatically from sleep, the office machine enters into sleep mode again upon receipt of a sleep command data.

After the office machine has woken up automatically from sleep mode, finished an office task, such as printing, scanning, and sending/receiving fax, captured a second user image and generated second feature data related thereto, the office machine enters into sleep mode again.

While the present disclosure has been described by means of specific embodiments, numerous modifications and variations could be made thereto by those skilled in the art without departing from the scope and spirit of the present disclosure set forth in the claims.

What is claimed is:

1. A control method of an office machine with intelligent sleep and wake function, the control method causing the office machine to at least perform the steps of:
capturing a first user image;
comparing a plurality of user data and first feature data related thereto with second feature data generated from the first user image to generate comparison result information; and
waking up the office machine automatically from sleep mode upon determination of user confirmation information according to the comparison result information.

2. The control method of an office machine with intelligent sleep and wake function according to claim 1, wherein the step of capturing the first user image is preceded by capturing a plurality of distance data and determining that one of the distance data reaches a distance threshold.

3. The control method of an office machine with intelligent sleep and wake function according to claim 1, wherein the second feature data comprises a face data, and, upon determination of the user confirmation information according to the comparison result information, the office machine wakes up automatically from sleep mode upon determination that the face data satisfies an angle data.

4. The control method of an office machine with intelligent sleep and wake function according to claim 1, wherein, after the office machine has woken up automatically from sleep mode, the office machine enters into sleep mode again upon receipt of a sleep command data.

5. The control method of an office machine with intelligent sleep and wake function according to claim 1, wherein, after the office machine has woken up automatically from sleep mode and finished an office task, the office machine enters into sleep mode again when capturing a second user image and generating second feature data related thereto.

6. An office machine with intelligent sleep and wake function, comprising:
a power supply module for supplying power to the office machine;
a storage module for storing a plurality of user data and first feature data related thereto;
an image module for capturing at least one first user image; and
a processing module connected to the power supply module, the storage module and the image module,
wherein the processing module generates second feature data according to the first user image, compares the second feature data with the first feature data related to the user data to generate comparison result information, and sends, upon determination of user confirmation information according to the comparison result information, a first control signal for driving the power supply module to enable the office machine to wake up automatically from sleep mode.

7. The office machine with intelligent sleep and wake function according to claim 6, wherein the image module comprises an image capturing unit for capturing the first user image and sending the first user image to the processing module.

8. The office machine with intelligent sleep and wake function according to claim 7, wherein the processing module further comprises:
an AI image processor for receiving and processing the first user image to generate the second feature data; and
a central processor connected to the AI image processor, adapted to receive the second feature data and compare the second feature data with the first feature data related to the user data to generate the comparison result information, and adapted to send, upon determination of the user confirmation information according to the comparison result information, the first control signal for driving the power supply module to enable the office machine to wake up automatically from sleep mode.

9. The office machine with intelligent sleep and wake function according to claim 8, wherein the first feature data each comprises a first face feature data, and the second feature data each comprises a second user face feature, such that the central processor compares the first face feature data with the second user face feature to generate the comparison result information.

10. The office machine with intelligent sleep and wake function according to claim 9, wherein the second feature data further comprises a face turning angle data, and, after determining the user confirmation information according to the comparison result information, the central processor further determines that the face turning angle data satisfies a turning angle range data and sends the first control signal for driving the power supply module to enable the office machine to wake up automatically from sleep mode.

11. The office machine with intelligent sleep and wake function according to claim 8, wherein the image module further comprises a distance measuring unit for capturing and sending a plurality of distance data to the central processor, wherein, before the image capturing unit captures the first user image, the central processor determines that one of the distance data received reaches a distance threshold and drives the image capturing unit to capture the first user image.

12. The office machine with intelligent sleep and wake function according to claim 8, wherein, after the office machine has woken up automatically from sleep mode and finished an office task, the central processor receives third feature data generated by the AI image processor according to a second user image captured by the image capturing unit and thereby sends a second control signal to the power supply module to drive the power supply module, thereby enabling the office machine to enter into sleep mode.

13. An office machine with intelligent sleep and wake function, the office machine connecting to a cloud server via a network, the cloud server storing a plurality of user data and first feature data related thereto, the office machine comprising:
a power supply module for supplying power to the office machine;
a connection module connected to the cloud server via the network and adapted to effect data exchange;
an image module for capturing at least one first user image; and
a processing module connected to the power supply module, the storage module and the image module,
wherein the processing module generates second feature data according to the first user image, sends the second feature data to the cloud server via the connection module so as for the second feature data to be processed at the cloud server, obtains comparison result information by exchange, and sends, upon determination of user confirmation information according to the comparison result information, a first control signal for driving the power supply module to enable the office machine to wake up automatically from sleep mode.

14. The office machine with intelligent sleep and wake function according to claim 13, wherein a data download request is sent to the cloud server via the connection module to download the user data and first feature data related thereto, and the downloaded user data and first feature data related thereto are stored in the storage module, such that the processing module compares the user data and first feature data related thereto stored in the storage module upon receipt of the second feature data.

15. The office machine with intelligent sleep and wake function according to claim 13, wherein the image module comprises an image capturing unit for capturing the first user image and sending the captured first user image to the processing module.

16. The office machine with intelligent sleep and wake function according to claim 15, wherein the processing module further comprises:
an AI image processor for receiving and processing the first user image to generate the second feature data; and
a central processor connecting to the AI image processor, receiving the second feature data, comparing the second feature data with the first feature data related to the user data to generate the comparison result information, determining the user confirmation information according to the comparison result information and thereby sending the first control signal for driving the power supply module to enable the office machine to wake up automatically from sleep mode.

17. The office machine with intelligent sleep and wake function according to claim 16, wherein the first feature data related to the user data each comprises a first face feature data, and the second feature data comprises a second user face feature, such that the central processor compares the first face feature data with the second user face feature to generate the comparison result information.

18. The office machine with intelligent sleep and wake function according to claim 17, wherein the second feature data further comprises a face turning angle data, and, after determining the user confirmation information according to the comparison result information, the central processor further determines that the face turning angle data satisfies a turning angle range data and then sends the first control signal for driving the power supply module to enable the office machine to wake up automatically from sleep mode.

19. The office machine with intelligent sleep and wake function according to claim 16, wherein the image module further comprises a distance measuring unit, and the distance measuring unit captures and sends a plurality of distance data to the central processor, wherein, before the image capturing unit captures the first user image, the central processor drives, upon determination that one of the distance data received reaches a distance threshold, the image capturing unit of the image module to capture the first user image.

20. The office machine with intelligent sleep and wake function according to claim 16, wherein, after the office machine has woken up automatically from sleep mode and finished an office task, the central processor receives third feature data generated by the AI image processor according to a second user image captured by the image capturing unit and thereby sends a second control signal to the power supply module to drive the power supply module, thereby enabling the office machine to enter into sleep mode.
